(19) United States
(12) Patent Application Publication
(10) Pub. No.: US 2009/0195839 A1
(43) Pub. Date: Aug. 6, 2009

(54) Image processing apparatus, image processing method and program thereof

(75) Inventors: Hiroshi Iezaki, Sapporo-shi (JP); Takashi Shimoda, Sapporo-shi (JP)

Correspondence Address: EDWARDS ANGELL PALMER & DODGE LLP, P.O. BOX 55874, BOSTON, MA, 02205, US

(73) Assignee: Seiko Epson Corporation, Tokyo (JP)

(21) Appl. No.: 12/322,403

(22) Filed: Feb. 2, 2009

(30) Foreign Application Priority Data
Feb. 4, 2008 (JP) 2008-023826

(51) Int. Cl. H04N 1/00; G09G 5/00; H04N 1/40

(52) U.S. Cl. 358/426.1; 345/619; 358/448

(57) ABSTRACT

Provided is an image processing apparatus including: a part storage unit which, among a plurality of parts obtained by dividing an icon included in a display image, stores end parts corresponding to ends of the icon and a plurality of repetition parts included in the divided icon; a correspondence information storage unit which stores correspondence information in which the icon, and the end parts and the repetition parts of the icon and the repeated number of the repetition parts correspond to each other; and a generation control unit which specifies the end parts and the repetition parts corresponding to the icon included in a generated image using the correspondence information stored in the correspondence information storage unit if an image generation instruction for generating a predetermined display image is acquired, reads the specified parts from the part storage unit, and generates the icon using the read end parts and repetition parts and the repeated number of the repetition parts corresponding to the correspondence information.

The entire disclosure of Japanese Patent Application No. 2008-023826, filed Feb. 4, 2008 is expressly incorporated by reference herein.

### BACKGROUND

1. Technical Field

The present invention relates to an image processing apparatus, an image processing method and a program thereof.

2. Related Art

In the related art, as an image processing apparatus, an image processing apparatus which has a communication function for receiving plural pieces of display data, stores the received plural pieces of display data, stores first icon information corresponding to the display data and second icon information different from a display format of the first icon information, selects the first or second icon information on the basis of the number of pieces of display data registered newly, and displays this icon on a menu screen such that a plurality of icons which are different in color or format can be realized with small memory consumption and the functions corresponding to the icons can be more easily recognized is suggested (for example, see JP-A-2001-202178).

However, in the image processing apparatus described in JP-A-2001-202178, an area for storing the icons is not considered. Accordingly, if the kinds of the icons which will be stored in the image processing apparatus are increased, the area for storing the icons is increased.

### SUMMARY

An advantage of some aspects of the invention is that it provides an image processing apparatus, an image processing method and a program thereof, which are capable of reducing an area for storing icons and representing various icons.

The invention employs the following aspects in order to accomplish the above-described advantage.

According to an aspect of the invention, there is provided an image processing apparatus including: a part storage unit which, among a plurality of parts obtained by dividing an icon included in a display image, stores end parts corresponding to ends of the icon and a plurality of repetition parts included in the divided icon; a correspondence information storage unit which stores correspondence information in which the icon, and the end parts and the repetition parts of the icon and the repeated number of the repetition parts correspond to each other; and a generation control unit which specifies the end parts and the repetition parts corresponding to the icon included in a generated image using the correspondence information stored in the correspondence information storage unit if an image generation instruction for generating a predetermined display image is acquired, reads the specified parts from the part storage unit, and generates the icon using the read end parts and repetition parts and the repeated number of the repetition parts corresponding to the correspondence information.

In this image processing apparatus, among the plurality of parts obtained by dividing an icon included in the display image, the end parts corresponding to the ends of the icon and the plurality of repetition parts included in the divided icon are stored, the correspondence information in which the icon, and the end parts and the repetition parts of the icon and the repeated number of the repetition parts correspond to each other is stored, the end parts and the repetition parts corresponding to the icon included in the generated display image are specified using the stored correspondence information if the image generation instruction for generating the predetermined display image is acquired, the specified parts are read, and the icon is generated using the read end parts and repetition parts and the repeated number of the repetition parts corresponding to the correspondence information. Since the icon is stored as the divided parts, it is possible to reduce the storage area, for example, compared with the storage of the icon itself. In addition, if the repeated number of the repetition parts is arbitrarily set, various icons can be generated, and various icons can be generated by variously combining the end parts. Accordingly, it is possible to reduce the area for storing the icon and represent various icons. Here, the “end parts” may be, for example, the parts of the four corners of the display image, or the parts of the left end portion and the right end portion of the display image, or the parts of the upper end portion and the lower end portion of the display image.

In the image processing apparatus of the invention, the generation control unit may buffer the generated icon in a buffer unit for temporarily storing data. The generated icon can be used later and the display image can be generated at a higher speed.

In the image processing apparatus of the invention, the part storage unit may store the end parts and the repetition parts as predetermined compression data, and the generation control unit may read the end parts and the repetition parts from the part storage unit, read the compression data of the end parts and the repetition parts from the part storage means in the generation of the icon, expand the image data of the end parts and the repetition parts from the read compression data, and buffer the expanded image data in the buffer unit for temporarily storing the data in a locked state. By this configuration, since the process of expanding the parts can be reduced, the display image can be generated at a higher speed. In addition, the expansion data of the parts smaller than the icon can be maintained with certainty and the icon can be generated using the expansion data at a higher speed. Here, the “locked state” indicates buffering to a state in which rewriting or erasing cannot be performed. In addition, the locked state may be released after the image process is completely finished. At this time, the part storage unit may store portable network graphics (PNG) data as the compression data. By this configuration, the storage area can be reduced using the PNG data including transparency information or the like and the image drawn using the transparency can be made more natural.

The image processing apparatus of the invention may further include a rectangular copy unit which copies a rectangular image using the end parts and the repetition parts read by the generation control unit in a successive and/or fragmental storage area, and the generation control unit may prepare the display image by copying the rectangular image using the rectangular copy unit. By this configuration, a fragmental image can be more easily copied and the display image can be prepared at a higher speed.

The image processing apparatus of the invention may further include a display unit which displays the image, and the generation control unit prepares the display image of the image generation instruction using the generated icon and displays and outputs the prepared display image to the display unit. By this configuration, the display image prepared by the generated icon can be visually provided.

According to another aspect of the invention, there is provided an image processing method by computer software using an image processing apparatus including a part storage unit which, among a plurality of parts obtained by dividing an icon included in a display image, stores end parts corresponding to ends of the icon and a plurality of repetition parts included in the divided icon, and a correspondence information storage unit which stores correspondence information in which the icon, and the end parts and the repetition parts of the icon and the repeated number of the repetition parts correspond to each other, the method including: specifying the end parts and the repetition parts corresponding to the icon included in a generated image using the correspondence information stored in the correspondence information storage unit if an image generation instruction for generating a predetermined display image is acquired; and reading the specified parts from the part storage unit, and generating the icon using the read end parts and repetition parts and the repeated number of the repetition parts corresponding to the correspondence information.

In this image processing method, since the icon is stored as the divided parts, it is possible to reduce the storage area, for example, compared with the storage of the icon itself. In addition, if the repeated number of the repetition parts is arbitrarily set, various icons can be generated, and various icons can be generated by variously combining the end parts. Accordingly, it is possible to reduce the area for storing the icon and represent various icons. In addition, in this image processing method, various aspects of the image processing apparatus may be employed and the steps of realizing the functions of the above-described image processing apparatus may be added.

The program of the invention realizes the steps of the above-described image processing method on one or a plurality of computers. This program may be recorded on a computer-readable recording medium (for example, a hard disc, a ROM, a FD, a CD, a DVD or the like), may be transmitted from any computer to another computer via a transmission medium (communication network such as the Internet or a LAN), or may be transmitted/received by other methods. If this program is executed on one computer or the steps are divided and executed on the plurality of computers, since the steps of the above-described processing method are executed, the same effect as the image processing method is obtained.

### BRIEF DESCRIPTION OF THE DRAWINGS

The invention will be described with reference to the accompanying drawings, wherein like numbers reference like elements.

FIG. 1 is a view showing the schematic configuration of a printer 20 according to an embodiment of the invention.

FIG. 2 is a view explaining information stored in a flash ROM 23.

FIG. 3 is a view showing explaining parts of icons stored in the flash ROM 23.

FIG. 4 is a flowchart showing an example of a display screen preparing process routine.

FIG. 5 is a view explaining a copy setting screen 50.

FIG. 6 is a view explaining information stored in a RAM 24.

### DESCRIPTION OF EXEMPLARY EMBODIMENTS

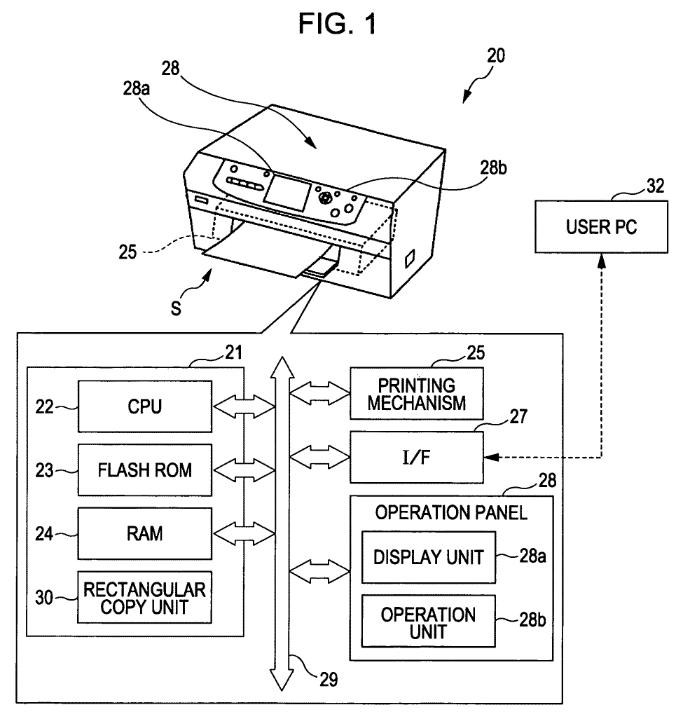

Hereinafter, embodiments of the invention will be described with reference to the accompanying drawings. FIG. 1 is a view showing the schematic configuration of a printer 20 according to an embodiment of the invention. The printer 20 includes a controller 21 for controlling the whole apparatus, a printing mechanism 25 for printing an image on a recording sheet S, an interface (I/F) 27 for inputting/outputting information to/from a connected external device (for example, a user PC 32), and an operation panel 28 for displaying information to a user and inputting an instruction of the user. The controller 21 or the printing mechanism 25, the I/F 27 and the operation panel 28 are electrically connected by buses 29. The controller 21 is configured by a microprocessor including a CPU 22, can store and erase information, and includes a flash ROM 23 for storing various data files or various application programs and a RAM 24 for temporarily storing data. The RAM 24 includes a buffer area for temporarily storing an image displayed on the operation panel 28. The controller 21 further includes a rectangular copy unit 30 which is an IC chip for copying a rectangular range including parts of icons displayed on a screen regardless of successive memory areas or a fragmental memory area, and is configured so generate a display screen using the rectangular copy unit 30. The printing mechanism 25, although not shown, is an ink jet mechanism for applying pressure inks of respective colors and ejecting the pressurized inks onto the recording sheet S so as to perform a printing process. In addition, a mechanism for applying pressure to the inks may be implemented by deforming a piezoelectric device or by generating air bubbles by the heat of a heater. The operation panel 28 is a device for allowing the user to input various instructions to the printer 20, and includes a display unit 28a which is a color liquid crystal panel for displaying characters or images according to various instructions, such as a touch panel, or an operation unit 28b for inputting the instructions of the user using various button.

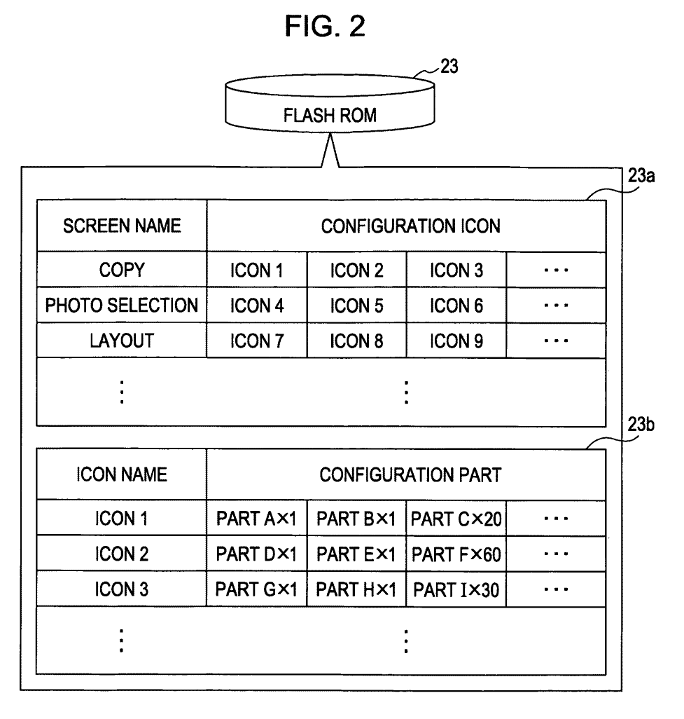

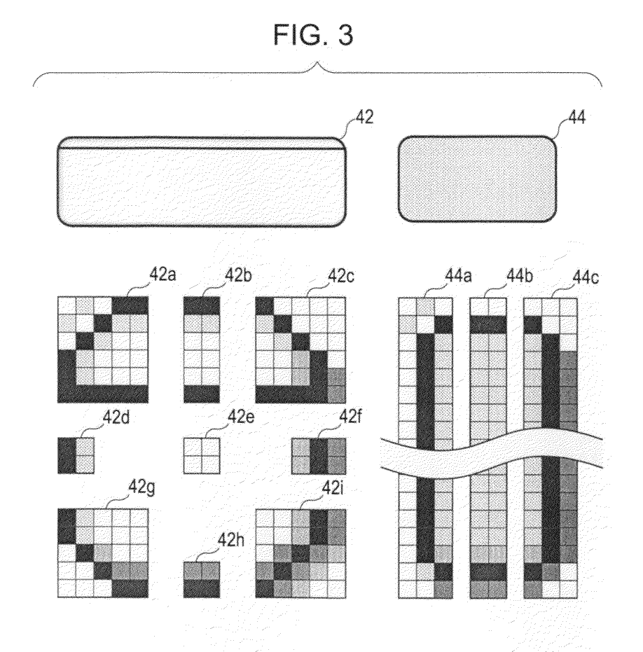

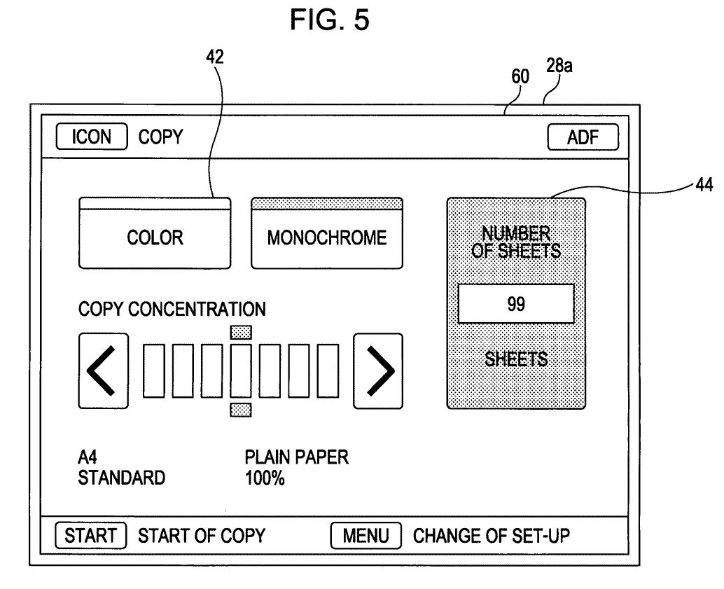

FIG. 2 is a view explaining information stored in the flash ROM 23, and FIG. 3 is a view showing explaining parts of icons stored in the flash ROM 23. In the flash ROM 23, screen correspondence information 23a, in which screen names used for a screen display and one or more icons configuring the screens correspond to each other, and icon correspondence information 23b, in which icon names and one or more parts configuring the icons and the number thereof correspond to each other, are stored. Using this information, the screens or images of the icons are prepared. The icon included in the display screen (see FIG. 5) is configured by a plurality of divided parts. For example, as shown in FIG. 3, a frame icon 42 is an vertically and horizontally asymmetrical frame and is configured by nine parts including a left upper end part 42a, an upper repetition part 42b, a right upper end part 42c, a left repetition part 42d, a central repetition part 42e, a right repetition part 42f, a left lower end part 42g, a lower repetition part 42h and a right lower part 42i. This frame icon 42 is formed by utilizing the end parts at four corners one by one and repeatedly arranging the repetition parts by a predetermined repeated number. In addition, a frame icon 44 is configured by three parts including a left end part 44a, a central repetition part 44b and a right end part 44c and is formed by repeatedly arranging the central repetition part 44b by a predetermined repeated number. In the flash ROM 23, these parts are compressed in a PNG file format which can specify transparent information and are stored. In this flash ROM 23, the parts of the icons are stored by the number of basic kinds of icons.

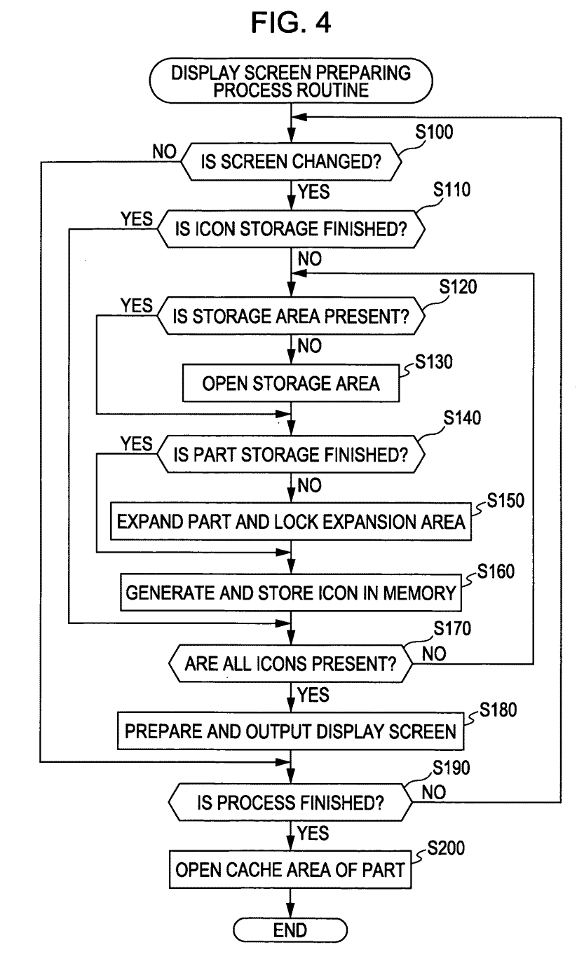

Next, the operation of the printer 20 of the present embodiment having the above-described configuration and, more particularly, the operation for preparing image data displayed by the display unit 28a will be described. FIG. 4 is a flowchart showing an example of a display screen preparing process routine, and FIG. 5 is a view explaining a copy setting screen 50. Now, the case where the copy setting screen 50 shown in FIG. 5 is prepared will be described in detail. In addition, when an icon of a touch panel is pressed by a user or an icon is scrolled and moved on the basis of a touch operation of the user, the image displayed by the display unit 28a is set to be changed (for example, a color is changed) such that the user can recognize the press of the icon. The display screen preparing process routine is stored in the flash ROM 23 and is executed after power is turned on. In addition, this display screen preparing process routine is executed using the rectangular copy unit 30 by the CPU 22 of the controller 21. If this routine is executed, the CPU 22 first determines whether or not a screen change (image generation instruction) is instructed depending on whether or not a screen change button is pressed by the operation of the operation unit 28b (step S100). In addition, in the step S100, even when a display screen does not appear immediately after the power is turned on, the determination results in affirmative. When the screen change is instructed, it is determined whether or not storage of one of the icons displayed by the display unit 28a in the RAM 24 is finished (step S110). This determination is performed by specifying the icons included in a screen displayed newly using the screen correspondence information 23a and determining whether or not the specified icons are stored in the buffer area of the RAM 24.

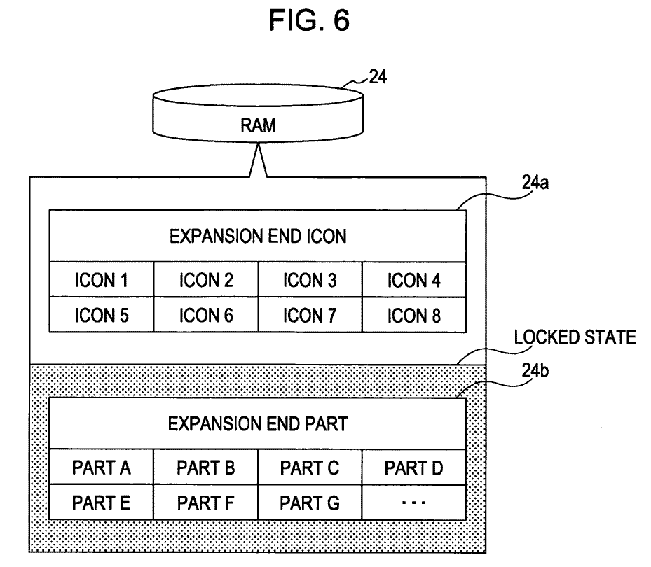

If the icons are not stored in the buffer area of the RAM 24, the CPU 22 determines whether or not the area for storing a new icon is present (step S120), and, if the new storage area is not present, for example, a storage area of an icon which is not used during a predetermined time is opened (step S130). If the area for storing the icon is present after the step S130 or in the step S120, the CPU 22 determines whether the storage of the part of this icon in the buffer area of the RAM 24 is finished (step S140). If the storage of the part of the icon is not finished, the part of this icon is specified using the icon correspondence information, the specified part is read from the flash ROM 23, is expanded to bitmap data, the image data of the expanded part is stored in the buffer area of the RAM 24 in a locked state (step S150). FIG. 6 is a view explaining the information stored in the RAM 24. When this routine is executed, an expansion end icon 24a for storing icons included in display screens and an expansion end part 24b which is image data configuring the icon after expansion are stored in the RAM 24. The expansion end part 24b is stored in the locked state in which rewriting or erasing cannot be performed while this routine is executed. Subsequently, an icon is generated using the repeated number of the repetition part included in the icon correspondence information and the parts stored in the RAM 24 and is stored in the RAM 24 (step S160). The generation of the icon is, for example, performed by generating a rectangular image which is a repetition unit and repeatedly copying the rectangular image by the rectangular copy unit 30. Therefore, since a high speed is obtained when the process is performed by hardware, rather than when the process is performed by software, it is possible to rapidly perform the icon generating process. For example, common parts which are different in only a width or only a length may be included according to the icons. By variously setting the repeated number, various icons can be generated by a smaller number of parts. Thus, the icons arranged in FIG. 3 or 5 are generated.

If the storage of the icon in the RAM 24 is finished after the step S160 or in the step S110, the CPU 22 determines whether or not all the icons included in the screen to be displayed are stored in the RAM 24 (step S170). If all the icons are not stored in the RAM 24, the process after the step S120 is executed and, if all the icons are stored in the RAM 24, the displayed screen is prepared, is stored in the RAM 24, and is displayed and output to the display unit 28a (step S180). The preparation of the display screen is performed by arranging the icon images buffered in the RAM 24 on the basis of the information included in the icon correspondence information. For example, the copy setting screen 50 shown in FIG. 5 is prepared.

If the screen change is not performed after the step S180 or in the step S100, the CPU 22 determines whether or not the process is finished depending on whether or not the power is turned off (step S190). If the process is not finished, the process after the step S100 is executed and, if the process is finished, the area in which the part is stored is opened (step S200) and this routine is completed.

Now, the correspondence between the components of the present embodiment and the components of the invention will be clarified. The flash ROM 23 of the present embodiment corresponds to a part storage unit and a correspondence information storage unit of the invention, the controller 21 corresponds to a generation control unit, the rectangular copy unit 30 corresponds to a rectangular copy unit, and the display unit 28a corresponds to a display unit. In addition, in the present embodiment, the example of the image processing method of the invention is clarified by explaining the operation of the printer 20.

According to the printer 20 of the above-described embodiment, when an image generation instruction for generating a predetermined display image is acquired, the end parts and repetition parts corresponding to the icon included in the generated display image are specified using the icon correspondence information 23b, the specified parts are read, and the icon is generated using the read end parts and repetition parts and the repeated number of the repetition parts. Since the icon is stored as the divided parts, it is possible to reduce the storage area, for example, compared with the storage of the icon itself. In addition, if the repeated number of the repetition parts is arbitrarily set, various icons can be generated, and various icons can be generated by variously combining the end parts. Accordingly, it is possible to reduce the area for storing the icon and represent various icons. Since the generated icon is buffered, the generated icon can be used later and the display image can be generated at a higher speed. In addition, since the end parts and the repetition parts are stored as PNG data which is compression data, the image data of the end parts and the repetition parts is expanded from the compression data in the generation of the icon, and the expanded image data is buffered in the RAM 24 in the locked state, the process of expanding the parts can be reduced and the display image can be generated at a higher speed. In addition, the expansion data of the parts smaller than the icon can be maintained with certainty and the icon can be generated using the expansion data at a higher speed. In addition, the storage area can be reduced using the PNG data including transparency information or the like and the image drawn using the transparency can be made more natural. Furthermore, since the display image is prepared by copying the rectangular image using the rectangular copy unit 30, a fragmental image can be more easily copied and the display image can be prepared at a higher speed. In addition, since the prepared display image is displayed and output to the operation panel 28, the display image prepared by the generated icon can be visually provided. In addition, since the display image can be prepared at a high speed, for example, the display image is easily activated by the operation of the user. Although a change occurs during the development of the screen, the contents can be relatively easily changed if the parts and the correspondence information are changed.

The invention is not limited to the above-described embodiment and various embodiments can be implemented within the technical scope of the invention.

For example, although the icon of which the central portion has the same color is described in the above-described embodiment, an icon having gradation therein may be used. Compared with the case where the icon having gradation is individually generated, it is possible to reduce the storage area in the case where the parts are combined so as to generate the icon.

Although the icon is generated and the screen is prepared using the rectangular copy unit 30 in the above-described embodiment, this process may be performed by software, without using the rectangular copy unit. Even in this case, it is possible to reduce the area for storing the icon and represent various icons. Although the part data is stored as the PNG data in the above-described embodiment, the invention is not specially limited to this and the part data may be stored in other file formats. In addition, the storage area of the flash ROM 23 can be ensured by the compression data.

Although the area for storing the parts is locked in the above-described embodiment, the area for storing the parts may not be locked. Although the generated icon or the expanded part is stored in the buffer, the buffer process may be omitted.

Although the printer 20 is described as the image processing apparatus of the invention in the above-described embodiment, the apparatus is not specially limited if the display image is prepared using the plurality of parts. For example, the invention is applicable to a multifunction printer including a scanner, a printing apparatus such as a FAX, or a user PC 32. In addition, the invention is applicable to an electronic apparatus such as a mobile telephone or a game apparatus. Although the printer 20 is described as the image processing apparatus, an image processing method or a program for executing this method may be provided.

What is claimed is:

1. An image processing apparatus comprising:
a part storage unit which, among a plurality of parts obtained by dividing an icon included in a display image, stores end parts corresponding to ends of the icon and a plurality of repetition parts included in the divided icon;
a correspondence information storage unit which stores correspondence information in which the icon, and the end parts and the repetition parts of the icon and the repeated number of the repetition parts correspond to each other; and
a generation control unit which specifies the end parts and the repetition parts corresponding to the icon included in a generated image using the correspondence information stored in the correspondence information storage unit if an image generation instruction for generating a predetermined display image is acquired, reads the specified parts from the part storage unit, and generates the icon using the read end parts and repetition parts and the repeated number of the repetition parts corresponding to the correspondence information.

2. The image processing apparatus according to claim 1, wherein the generation control unit buffers the generated icon in a buffer unit for temporarily storing data.

3. The image processing apparatus according to claim 1, wherein:
the part storage unit stores the end parts and the repetition parts as predetermined compression data, and
the generation control unit reads the end parts and the repetition parts from the part storage unit, reads the compression data of the end parts and the repetition parts from the part storage means in the generation of the icon, expands the image data of the end parts and the repetition parts from the read compression data, and buffers the expanded image data in the buffer unit for temporarily storing the data in a locked state.

4. The image processing apparatus according to claim 3, wherein the part storage unit stores portable network graphics (PNG) data as the compression data.

5. The image processing apparatus according to claim 1, further comprising a rectangular copy unit which copies a rectangular image using the end parts and the repetition parts read by the generation control unit in a successive and/or fragmental storage area,
wherein the generation control unit prepares the display image by copying the rectangular image using the rectangular copy unit.

6. The image processing apparatus according to claim 1, further comprising a display unit which displays the image,
wherein the generation control unit prepares the display image of the image generation instruction using the generated icon and displays and outputs the prepared display image to the display unit.

7. An image processing method by computer software using an image processing apparatus including a part storage unit which, among a plurality of parts obtained by dividing an icon included in a display image, stores end parts corresponding to ends of the icon and a plurality of repetition parts included in the divided icon, and a correspondence information storage unit which stores correspondence information in which the icon, and the end parts and the repetition parts of the icon and the repeated number of the repetition parts correspond to each other, the method comprising:
specifying the end parts and the repetition parts corresponding to the icon included in a generated image using the correspondence information stored in the correspondence information storage unit if an image generation instruction for generating a predetermined display image is acquired; and
reading the specified parts from the part storage unit, and generating the icon using the read end parts and repetition parts and the repeated number of the repetition parts corresponding to the correspondence information.

8. A recording medium, having a program for executing the image processing method according to claim 7 on one or more computers.
